(19) United States
(12) Patent Application Publication
(10) Pub. No.: US 2015/0158365 A1
(43) Pub. Date: Jun. 11, 2015

(54) VEHICULAR AIR CONDITIONER

(71) Applicant: DENSO CORPORATION, Kariya-city, Aichi-pref. (JP)

(72) Inventor: Minoru Hashimoto, Okazaki-city (JP)

(21) Appl. No.: 14/374,577

(22) PCT Filed: Jan. 29, 2013
(86) PCT No.: PCT/JP2013/000456

§ 371 Date: Jul. 25, 2014

(30) Foreign Application Priority Data
Feb. 6, 2012 (JP) 2012-022889

(51) Int. Cl. B60H 1/00; F28F 27/00

(52) U.S. Cl. CPC B60H 1/00007; F28F 27/00

(57) ABSTRACT

A vehicular air conditioner includes an evaporator bypass passage through which air is guided to a vehicle-compartment inside outlet with bypassing an evaporator, an inflow-side open-close door and an outflow-side open-close door that open or close the evaporator bypass passage and a cool-air passage through which air is guided to the vehicle-compartment inside outlet through the evaporator, an air-outlet door that opens or closes the vehicle-compartment inside outlet, and a controller. The controller controls the respective open-close doors to open the evaporator bypass passage and to substantially close the cool-air passage, and controls the air-outlet door to open the vehicle-compartment inside outlet, when an evaporation condition for evaporation of condensed water attached to the evaporator is satisfied.

### CROSS REFERENCE TO RELATED APPLICATION

This application is based on and incorporates herein by reference Japanese Patent Application No. 2012-022889 filed on Feb. 6, 2012.

### TECHNICAL FIELD

The present disclosure relates to a vehicular air conditioner including a cooling heat exchanger which cools air that is to be blown into a vehicle compartment.

### BACKGROUND ART

In the past, there has been a vehicular air conditioner including an evaporator of a vapor-compression refrigeration cycle, and the evaporator is used as a cooling heat exchanger which cools air that is to be blown into a vehicle compartment.

Such vehicular air conditioner may convey unpleasant odor, which remains in a casing accommodating the cooling heat exchanger, to the vehicle compartment along with the blown air when the vehicular air conditioner is activated.

When the cooling heat exchanger increases in temperature due to, for example, stop of refrigerant supply to the cooling heat exchanger, condensed water (water to be drained) attached to an outer surface of the cooling heat exchanger may evaporate. Accordingly, wet air may be blown into the vehicle compartment, and a window may be fogged. In this case, an unpleasant-odor component dissolved in the condensed water may be separated from the condensed water, and odorous air may be blown into the vehicle compartment.

In Patent Document 1, for example, a technology is disclosed, in that air which has passed through the cooling heat exchanger is emitted to outside a vehicle, not into a vehicle compartment, immediately after an activation of an air conditioner or during a stop of the air conditioner.

Additionally, in Patent Document 2, a technology is disclosed, in that an air outlet through which air is blown into a vehicle compartment is closed, and condensed water attached to an outer surface of the air conditioner is discharged along with wet air to outeside a vehicle via a drainage port, when the air conditioner is activated. Accordingly, flowing of the condensed water on the outer surface of the air conditioner into the vehicle compartment and blowing of wet air into the vehicle compartment are restricted for protection of window fogging.

### PRIOR ART DOCUMENT

### Patent Document

Patent Document 1: JP 11-129729 A

Patent Document 2: JP 2006-150992 A

### SUMMARY OF THE INVENTION

According to a study of the inventors of the present application, the conventional technologies described in Patent Documents 1 and 2 are capable of restricting the unpleasant odor in the vehicle compartment and the window fogging. However, when air that has passed through the cooling heat exchanger is discharged to outside the vehicle compartment, no air is blown into the vehicle compartment. Thus, an air conditioning function of the air conditioner may not be fulfilled at all.

In consideration of the above-described points, it is an objective of the present disclosure to provide a vehicular air conditioner capable of fulfilling its air conditioning function with restricting unpleasant odor and window fogging in a vehicle compartment.

To achieve the above-described objective, a vehicular air conditioner of the present disclosure includes a casing having a vehicle-compartment inside outlet (12, 13, 14), a blower device that blows air, a cooling heat exchanger that cools the air blown by the blower device, a bypass passage through which the blown air is guided to the vehicle-compartment inside outlet with bypassing the cooling heat exchanger, a passage open-close portion that opens or closes the bypass passage and a cool-air passage through which the blown air is guided to the vehicle-compartment inside outlet through the cooling heat exchanger, an air-outlet open-close portion that opens or closes the vehicle-compartment inside outlet, and a control portion that controls the passage open-close portion and the air-outlet open-close portion. The control portion controls the passage open-close portion to open the bypass passage and to substantially close the cool-air passage, and controls the air-outlet open-close portion to open the vehicle-compartment inside outlet, when an evaporation condition for evaporation of condensed water attached to the cooling heat exchanger is satisfied.

According to the above, when the evaporation condition is satisfied, in other words, when unpleasant odor or window fogging occurs easily, air blown by the blower can be blown out of the vehicle-compartment inside outlet via the bypass passage bypassing the cooling heat exchanger. Accordingly, the air can be blown into the vehicle compartment through the bypass passage while the unpleasant odor in the vehicle compartment and the window fogging are restricted.

Therefore, according to the present disclosure, an air conditioning function of the vehicular air conditioner can be fulfilled while the unpleasant odor and the window fogging in the vehicle compartment are restricted. The description “substantially close the cool-air passage” means not only that the cool-air passage is completely closed, but also that the cool-air passage is slightly open such that a little air flows through the cool-air passage.

### BRIEF DESCRIPTION OF THE DRAWINGS

FIG. 1 is a schematic diagram showing a vehicular air conditioner according to a first embodiment.

FIG. 2 is a diagram showing operating characteristics of an inflow-side open-close door and an outflow-side open-close door according to the first embodiment.

FIG. 3 is a schematic diagram showing a flow of air in an interior air-conditioning unit when an evaporation condition is dissatisfied, according to the first embodiment.

FIG. 4 is a schematic diagram showing a flow of air in the interior air-conditioning unit when the evaporation condition is satisfied, according to the first embodiment.

FIG. 5 is a diagram showing operating characteristics of an inflow-side open-close door and an outflow-side open-close door according to a second embodiment.

FIG. 6 is a schematic diagram showing a flow of air in an interior air-conditioning unit when an evaporation condition is satisfied, according to the second embodiment.

### EMBODIMENTS FOR EXPLOITATION OF THE INVENTION

Hereinafter, multiple embodiments for implementing the present invention will be described referring to drawings. In the respective embodiments, a part that corresponds to a matter described in a preceding embodiment may be assigned the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

Hereinafter, the embodiments of the present disclosure will be described with reference to the drawings. Among the following respective embodiments, parts same as or equivalent to each other are assigned the same numeral in the drawings.

### First Embodiment

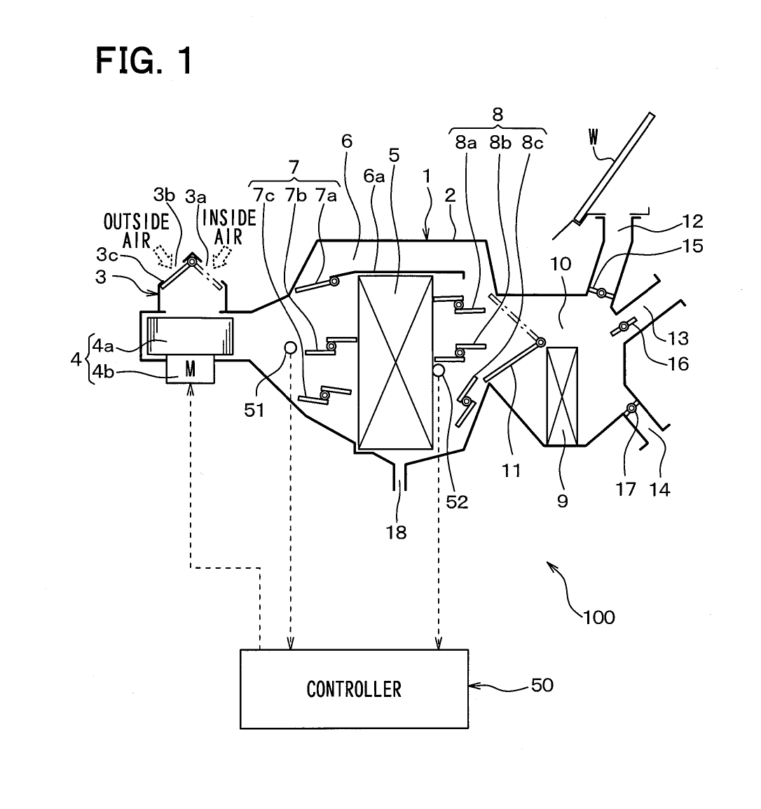

A vehicular air conditioner 100 according to a first embodiment of the present disclosure includes an interior air-conditioning unit 1, a non-shown refrigeration cycle and an air-conditioning controller 50, as shown in a whole-configuration diagram of FIG. 1.

The interior air-conditioning unit 1 is disposed inside a dashboard (instrument panel) in a front part of a vehicle compartment, and includes a blower 4, an evaporator 5 and heater core 9 inside a casing 2 that constitutes an outer shell of the interior air-conditioning unit 1.

The casing 2 has an air passage through which air is blown into the vehicle compartment. The casing 2 has elasticity to some extent and is made of resin (e.g., polypropylene) superior in strength. An inside-outside air switching box 3 is disposed in a most upstream part inside the casing 2 in an air flow, and the inside-outside air switching box 3 switches between an air pathway through which air (outside air) outside the vehicle compartment flows into the air passage in the casing 2 and an air pathway through which air (inside air) inside the vehicle compartment flows into the air passage in the casing 2.

The inside-outside air switching box 3 includes an inside-air introduction port 3a, through which the inside air is introduced into the air passage in the casing 2, and an outside-air introduction port 3b, through which the outside air is introduced into the air passage in the casing 2. An inside-outside air switching door 3c is disposed in the inside-outside air switching box 3 to change a ratio in flow rate between the inside air and the outside air introduced into the casing 2 by regulating open areas of the inside-air introduction port 3a and the outside-air introduction port 3b continuously.

The inside-outside air switching door 3c functions to switch an air-inlet mode by varying the ratio in flow rate between the inside air and the outside air introduced into the air passage in the casing 2. The air-inlet mode includes an inside-air mode and outside-air mode. In the inside-air mode, the inside-air introduction port 3a is fully open, the outside-air introduction port 3b is fully closed, and the inside air is thus introduced into the casing 2. In the outside-air mode, the outside-air introduction port 3b is fully open, the inside-air introduction port 3a is fully closed, and the outside air is thus introduced into the casing 2. An operation of the inside-outside air switching door 3c is controlled by a control signal outputted from the air-conditioning controller 50.

The blower 4 is disposed downstream of the inside-outside air switching box 3 in the air flow. The blower 4 may be used as an example of a blower device that blows air that has been drawn therein through the inside-outside air switching box 3. The blower 4 is an electric blower in which a centrifugal multi-blade fan 4a (sirocco fan) is driven by an electric motor 4b, and a rotation rate (air blowing amount) of the electric motor 4b is controlled by a control signal outputted from the air-conditioning controller 50.

The evaporator 5 is disposed downstream of the blower 4 in the air flow. The evaporator 5 may be used as an example of a cooling heat exchanger which cools air blown from the blower 4 to the vehicle compartment via heat exchange between the air and refrigerant flowing in the evaporator 5.

Specifically, the evaporator 5 constitutes a vapor-compression refrigeration cycle together with a compressor, a condenser and an expansion valve. The compressor compresses and discharges refrigerant, and the condenser condenses the refrigerant discharged from the compressor by radiating heat of the refrigerant to an external air. The expansion valve depressurizes and expands the refrigerant condensed in the condenser. In the evaporator 5 of the present embodiment, the refrigerant which has been depressurized and expanded by the expansion valve evaporates to exert a heat absorption effect. Accordingly, the blown air is cooled in the evaporator 5.

The casing 2 of the present embodiment has an evaporator bypass passage 6 as a bypass passage through which the air blown from the blower 4 is guided to vehicle-compartment inside outlets 12 to 14 positioned downstream of the evaporator 5 without passing through the evaporator 5. In the present embodiment, a partition member 6a is provided along a side of the evaporator 5 in the casing 2. A cool-air passage, through which the blown air is guided to the vehicle-compartment inside outlets 12 to 14 positioned downstream of the evaporator 5 through the evaporator 5, and the evaporator bypass passage 6 are defined by the partition member 6a.

An inflow-side open-close door 7 is disposed between the blower 4 and the evaporator 5 and between the blower 4 and the evaporator bypass passage 6 in the casing 2. The inflow-side open-close door 7 opens or closes the cool-air passage, through which the blown air is guided to the vehicle-compartment inside outlets 12 to 14 positioned downstream of the evaporator 5 through the evaporator 5, and the evaporator bypass passage 6.

The inflow-side open-close door 7 of the present embodiment includes a first inflow-side door 7a that opens or closes the evaporator bypass passage 6 with opening or closing a part of an air inflow surface of the evaporator 5, and second and third inflow-side doors 7b and 7c that open or close the other part of the air inflow surface of the evaporator 5.

An outflow-side open-close door 8 is disposed downstream of the evaporator 5 in the air flow, and opens or closes an air-outflow side of the evaporator 5. The outflow-side open-close door 8 of the present embodiment includes first to third outflow-side doors 8a, 8b, 8c, and the respective outflow-side doors 8a to 8c open or close the air-outflow side of the evaporator 5.

The open-close doors 7 and 8 of the present embodiment may be each used as a passage open-close portion that opens or closes the cool-air passage, through which the blown air guided to the vehicle-compartment inside outlets 12 to 14 positioned downstream of the evaporator 5 through the evaporator 5, and the evaporator bypass passage 6. Specifically, the inflow-side open-close door 7 functions as an inflow-side open-close portion that opens or closes the air-inflow side of the evaporator 5 in the cool-air passage, and the outflow-side open-close door 8 functions as an outflow-side open-close portion that opens or closes the air-outflow side of the evaporator 5 in the cool-air passage.

The open-close doors 7 and 8 of the present embodiment are each coupled to a driving member (e.g., servomotor) that drives the respective open-close doors 7 and 8 via a non-shown link mechanism, and are operated to be rotated in conjunction with each other. An operation of the driving member of the respective open-close doors 7 and 8 is controlled by a control signal outputted from the air-conditioning controller 50.

The heater core 9 is disposed downstream of the outflow-side open-close door 8 and the evaporator bypass passage 6 in the air flow, and heats the air flowing in the casing 2. The heater core 9 is a heating heat exchanger that heats air, which has passed through the evaporator 5 or the evaporator bypass passage 6, by using, as a heat source, an engine coolant that cools an engine.

A heater-core bypass passage 10 is provided on a side of the heater core 9. The heater-core bypass passage 10 is a passage through which the air that has passed through the evaporator 5 or the evaporator bypass passage 6 flows downstream without passing through the heater core 9. Therefore, a temperature of the blown air mixed on a downstream side of the heater core 9 and the heater-core bypass passage 10 in the air flow changes depending on a ratio in flow rate between air passing through the heater core 9 and air passing through the heater-core bypass passage 10.

In the present embodiment, an air mix door 11 is disposed on downstream sides of the evaporator 5 and the evaporator bypass passage 6 and on upstream sides of the heater core 9 and the heater-core bypass passage 10. The air mix door 11 continuously changes a ratio in flow rate between air flowing into the heater core 9 and air flowing into the heater-core bypass passage 10. Therefore, the air mix door 11 constitutes a temperature regulation device that regulates the temperature of the blown air mixed on the downstream side of the heater core 9 and the heater-core bypass passage 10 in the air flow.

The air mix door 11 of the present embodiment is coupled to a driving member that drives the air mix door 11, and the air mix door 11 is driven to be rotated accordingly. An operation of the driving member is controlled by a control signal outputted from the air-conditioning controller 50.

The vehicle-compartment inside outlets 12 to 14 are provided in a most downstream part of the casing 2 in the air flow. The blown air conditioned in temperature is blown out through the vehicle-compartment inside outlets 12 to 14 into the vehicle compartment that is a space to be air-conditioned. In the present embodiment, the vehicle-compartment inside outlets 12 to 14 include a defroster air outlet 12 through which conditioned air is blown out to an inner surface of a glass window W on a front side of the vehicle, a face air outlet 13 through which conditioned air is blown out to an upper part of a passenger in the vehicle compartment, and a foot air outlet 14 through which conditioned air is blown out to a foot area of the passenger.

Air-outlet open-close doors are disposed upstream of the vehicle-compartment inside outlets 12 to 14 in the air flow. The air-outlet open-close doors may be used as examples of an air-outlet open-close portion that opens or closes the vehicle-compartment inside outlets 12 to 14. The air-outlet open-close doors include a defroster air-outlet door 15 that regulates an open area of the defroster air outlet 12, a face air-outlet door 16 that regulates an open area of the face air outlet 13, and a foot air-outlet door 17 that regulates an open area of the foot air outlet 14. The air-outlet doors 15 to 17 constitute an air-outlet-mode switching device that switches an air outlet mode. The air-outlet doors 15 to 17 are coupled to a driving member that drives the respective air-outlet doors 15 to 17 via a non-shown link mechanism. The air-outlet doors 15 to 17 is driven to be rotate in conjunction with each other. An operation of the driving member is controlled by a control signal outputted from the air-conditioning controller 50.

The casing 2 has a drainage port 18 on a lower side of the evaporator 5, and a water (condensed water) condensed from air in the evaporator 5 is discharged through the drainage port 18 to outside the vehicle. When the above-described outflow-side open-close door 8 closes the air-outflow side of the evaporator 5, air that has passed through the evaporator 5 flows through the drainage port 18 of the present embodiment. Hence, the drainage port 18 functions as a vehicle-compartment outside outlet through which air that has flowed into the evaporator 5 is discharged to outside the vehicle compartment. The outflow-side open-close door 8 of the present embodiment functions also as an air-outlet open-close portion that opens or closes the drainage port 18 used as the vehicle-compartment outside outlet.

Next, an electric control portion of the present embodiment will be described. The air-conditioning controller 50 includes a known microcomputer including CPU, ROM and RAM, and a peripheral circuit of the microcomputer. The air-conditioning controller 50 performs various calculations and processing based on an air-conditioning control program stored in a storage device such as the ROM, and controls operations of various devices connected to an output side of the air-conditioning controller 50.

The output side of the air-conditioning controller 50 is connected to various air-conditioning control devices. Specifically, the air-conditioning controller 50 is connected to the electric motor 4b for the blower 4, the driving member for the inflow-side open-close door 7 and the outflow-side open-close door 8, the driving member for the air mix door 11, the driving member for the respective air-outlet doors 15 to 17, and connected to the compressor of the refrigeration cycle, for example. The air-conditioning controller 50 of the present embodiment may be used as an example of a control portion that is integrated with a control device (hardware and software) that controls the above-described air-conditioning control devices.

An input side of the air-conditioning controller 50 is connected to an air-conditioning control sensor group that includes an outside air sensor that detects an external temperature, an inside air sensor that detects a temperature of inside the vehicle compartment, an insolation sensor that detects an insolation amount in the vehicle compartment, a thermo-hygro sensor 51 that detects a temperature and a humidity of air flowing into the evaporator 5, an evaporator temperature sensor 52 that detects a temperature of the evaporator 5. The evaporator temperature sensor 52 may be used as an example of a heat-exchanger temperature sensor that detects a temperature of the cooling heat exchanger.

The thermo-hygro sensor 51 of the present embodiment employs a temperature and humidity detector in which a humidity sensor, used as a humidity detection device that detects a relative humidity of the inflow air in the evaporator 5, and a temperature sensor, used as a temperature detection device that detects a temperature of the inflow air flowing into the evaporator 5, are integrated. The thermo-hygro sensor 51 may employ a temperature and humidity detector in which the humidity sensor and the temperature sensor are separately provided.

The evaporator temperature sensor 52 of the present embodiment employs a temperature detection device that specifically detects a temperature of a heat-exchange fin of the evaporator 5. The evaporator temperature sensor 52 may employ a temperature detection device that detects a temperature of another position of the evaporator 5, or may employ a temperature detection device that directly detects a temperature of refrigerant flowing in the evaporator 5. Further, the evaporator temperature sensor 52 may employ a temperature detection device that detects a temperature of air just after the air flows out of the evaporator 5.

Additionally, the input side of the air-conditioning controller 50 is connected to a non-shown control panel disposed near the dashboard in the front part of the vehicle compartment, and an operational signal is imputed to the air-conditioning controller 50 from various air-conditioning control switches provided on the control panel. The air-conditioning controller 50 of the present embodiment calculates a target temperature TAO based on detection signals from the outside air sensor, the inside air sensor and the insolation sensor and based on a setting temperature inside the vehicle compartment.

Next, operations of the vehicular air conditioner 100 of the present embodiment will be described. When an operational signal of the vehicular air conditioner 100 is inputted from the control panel to the air-conditioning controller 50, the air-conditioning controller 50 executes an air-conditioning control program. When the air-conditioning control program is executed, detection signals of the air-conditioning control sensor group and operational signals of the control panel are read in, and the target air blowing temperature TAO of air blown into the vehicle compartment is calculated based on the various signals read in.

The air-conditioning controller 50 determines control states of the various air-conditioning control devices based on the detection signals of the air-conditioning control sensor group and the target air blowing temperature TAO, and outputs control signals to the various air-conditioning control devices so as to obtain the determined control states.

For example, the blower 4 is controlled to make an air blowing amount be approximately a largest amount when the target air blowing temperature TAO is in an extremely low temperature range (maximum cooling range) or in an extremely high temperature range (maximum heating range), and the blower 4 is controlled to reduce the air blowing amount as the target air blowing temperature TAO approaches a middle temperature range.

Regarding the air mix door 11, an open degree of the air mix door 11 is controlled based on, for example, a detection signal of the evaporator temperature sensor 52 and the target air blowing temperature TAO so that a temperature of air blown into the vehicle compartment approaches the target air blowing temperature TAO. The respective air-outlet doors 15 to 17 are controlled such that the air outlet mode is switched in the order: face mode→bi-level mode→foot mode, with increase of the target air blowing temperature TAO from a low temperature range to a high temperature range.

In the vehicular air conditioner 100, when air conditioning is started or stopped, condensed water attached to the evaporator 5 may evaporate due to temperature change of the evaporator 5. Thus, there is a tendency to generate wet air around the evaporator 5 due to the evaporation of condensed water. The wet air constitutes a factor for unpleasant odor or window fogging in the vehicle compartment.

The air-conditioning controller 50 of the present embodiment determines whether an evaporation condition for the evaporation of condensed water attached to the evaporator 5 is satisfied or not when the condensed water attached to the evaporator 5 evaporates. The air-conditioning controller 50 controls the respective open-close doors 7 and 8 depending on a result of the determination.

The evaporation condition for the evaporation of condensed water attached to the evaporator 5 will be described. When a water amount contained in air flowing into the evaporator 5 is smaller than a water amount held by the evaporator 5, the water condensed attached to the evaporator 5 evaporates and transfers to the air. Therefore, the evaporation condition can be determined based on a magnitude relationship between the water amount contained in the air flowing into the evaporator 5 and the water amount held by the evaporator 5.

For example, the air-conditioning controller 50 of the present embodiment calculates a dew-point temperature correlated with the water amount contained in the air flowing into the evaporator 5 based on the detection signal of the thermo-hygro sensor 51, and determines the evaporation condition based on a magnitude relationship between the dew-point temperature and a detection signal of the evaporator temperature sensor 52. In this case, when a relationship: “the dew-point temperature of air flowing into the evaporator 5 is smaller than a detection temperature of the evaporator temperature sensor 52” is satisfied, the evaporation condition may be determined to be satisfied.

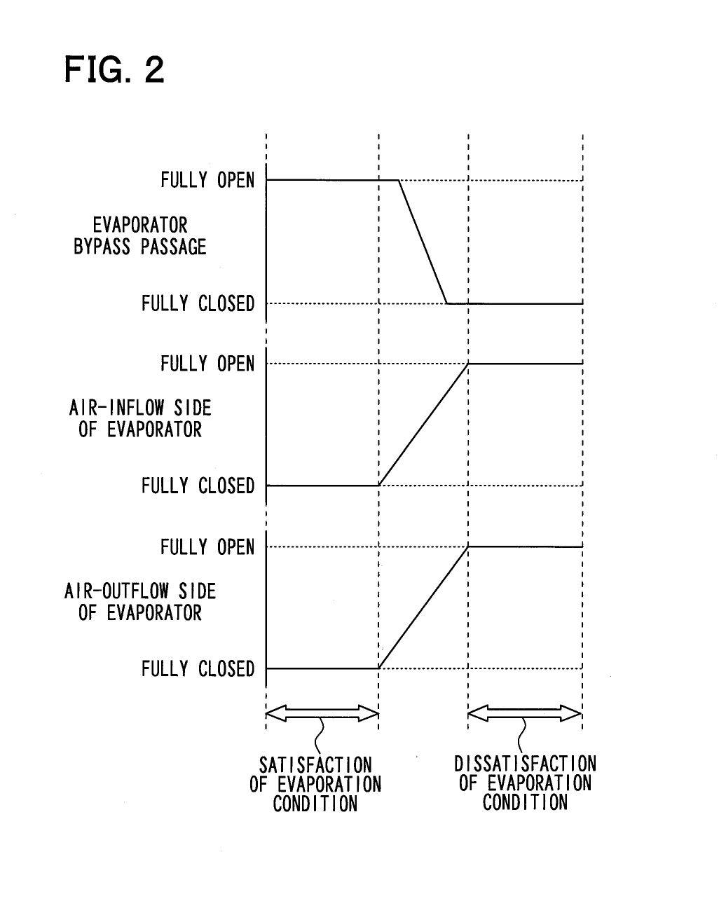

When the above-described evaporation condition is dissatisfied, in other words, when the dew-point temperature of air flowing into the evaporator 5 is higher than or equal to the detection temperature of the evaporator temperature sensor 52, water contained in air flowing into the evaporator 5 condenses on an outer surface of the evaporator 5. Thus, when the evaporation condition is dissatisfied, as shown in an operational-characteristic diagram of FIG. 2, the air-conditioning controller 50 controls the open-close doors 7 and 8 to close the evaporator bypass passage 6, to open the air-inflow side of the evaporator 5, and to open the air-outflow side of the evaporator 5. The air-conditioning controller 50 controls the air-outlet doors 15 to 17 to open at least one of the vehicle-compartment inside outlets 12 to 14.

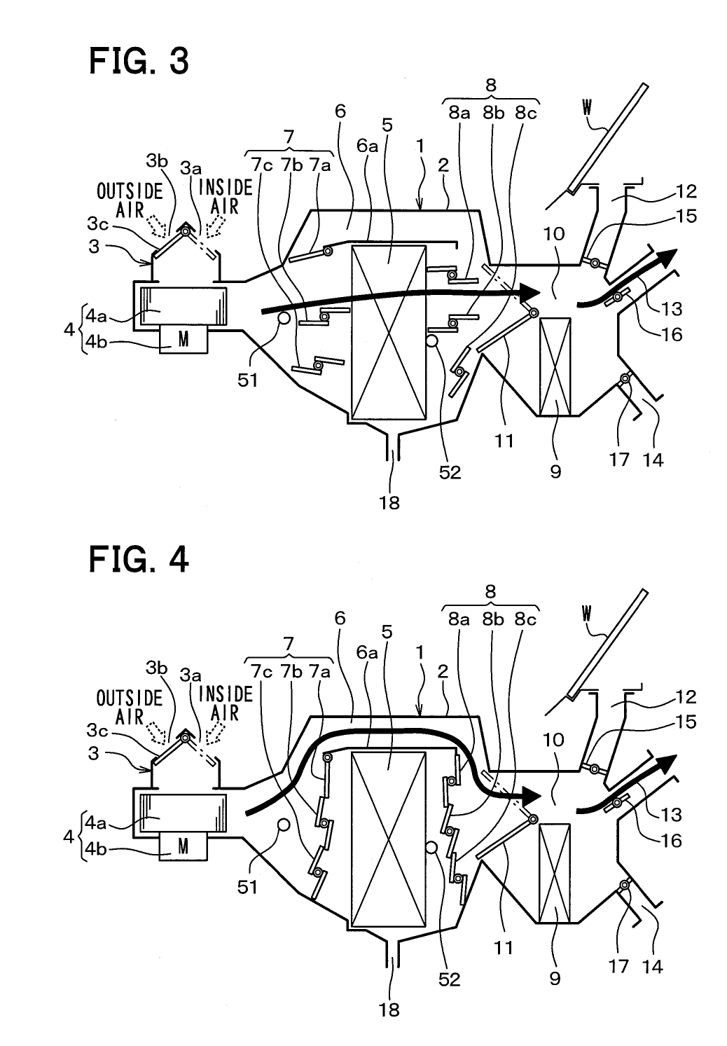

Accordingly, as shown in a whole configuration diagram of FIG. 3, air blown by the blower 4 flows into the evaporator 5 and is cooled therein. A part of the air is heated in the heater core 9 depending on the open degree of the air mix door 11. Subsequently, warm air that has passed through the heater core 9 and cool air that has passed through the heater-core bypass passage 10 are mixed on the downstream side of the heater core 9 and the heater-core bypass passage 10, thereby becoming air conditioned in temperature. The temperature-conditioned air is blown into the vehicle compartment through the vehicle-compartment inside outlets 12 to 14 depending on open and closed states of the air-outlet doors 15 to 17.

On the other hand, when the above-described evaporation condition is satisfied, in other words, when the dew-point temperature of air flowing into the evaporator 5 is lower than the detection temperature of the evaporator temperature sensor 52, water held by the evaporator 5 evaporates and transfers to the air.

Hence, when the evaporation condition is satisfied, as shown in the operational-characteristic diagram of FIG. 2, the air-conditioning controller 50 controls the open-close doors 7 and 8 to open the evaporator bypass passage 6, to close the air-inflow side of the evaporator 5, and to close the air-outflow side of the evaporator 5. Additionally, the air-conditioning controller 50 controls the air-outlet doors 15 to 17 to open at least one of the vehicle-compartment inside outlets 12 to 14. In this case, since both the air-inflow side and the air-outflow side of the evaporator 5 are closed by the open-close doors 7 and 8, the evaporator 5 is isolated from a passage through which air flows in the casing 2.

Accordingly, as shown in a whole configuration diagram of FIG. 4, air blown by the blower 4 flows into the evaporator bypass passage 6 with bypassing the evaporator 5. The air that has flowed into the evaporator bypass passage 6 is heated in the heater core 9 depending on the open degree of the air mix door 11. Subsequently, warm air that has passed through the heater core 9 and air that has passed through the heater-core bypass passage 10 are mixed on the downstream sides of the heater core 9 and the heater-core bypass passage 10, thereby becoming air conditioned in temperature. The temperature-conditioned air is blown into the vehicle compartment through the vehicle-compartment inside outlets 12 to 14 depending on open and closed states of the air-outlet doors 15 to 17.

In the vehicular air conditioner 100 of the present embodiment described above, when the evaporation condition is satisfied, in other words, when the unpleasant odor or the window fogging occurs easily due to the evaporation of condensed water on the evaporator 5, the air from the blower 4 is made to blown out of the vehicle-compartment inside outlets 12 to 14 through the evaporator bypass passage 6.

Accordingly, when the evaporation condition is satisfied, the air from the blower 4 does not flow into the evaporator 5, and the evaporation of condensed water attached to the evaporator 5 is restricted. Thus, the unpleasant odor and the window fogging can be limited.

Additionally, when the evaporation condition is satisfied, the evaporator bypass passage 6 is opened, and the vehicle-compartment inside outlets 12 to 14 are opened. Hence, air can be blown into the vehicle compartment through the evaporator bypass passage 6.

Therefore, in the vehicular air conditioner 100 of the present embodiment, an air-conditioning function of the vehicular air conditioner 100 can be fulfilled while the unpleasant odor in the vehicle compartment and the window fogging are restricted.

In the present embodiment, when the evaporation condition is satisfied, the open-close doors 7 and 8 close both the air-inflow side and the air-outflow side of the evaporator 5. Thus, the evaporator 5 can be isolated from the passage through which the air flows in the casing 2. As a result, it can be effectively restricted that unpleasant odor or wet air caused by evaporation of the condensed water attached to the evaporator 5 is blown into the vehicle compartment.

In a conventional vehicular air conditioner 100, even when it is unnecessary to cool air in an evaporator 5, a refrigeration cycle is activated to supply refrigerant to the evaporator 5 for prevention of evaporation of condensed water attached to the evaporator 5. The activation of the refrigeration cycle when it is unnecessary to cool air in the evaporator 5 may become a factor in inhibiting power saving of the vehicular air conditioner 100.

With respect to this, the vehicular air conditioner 100 of the present embodiment is capable of restricting the evaporation of condensed water attached to the evaporator 5 only by controlling the open-close doors 7 and 8 while an operation of the refrigeration cycle is stopped. Therefore, the vehicular air conditioner 100 of the present embodiment is effective also in the power saving of the air conditioner.

### Second Embodiment

Next, a second embodiment of the present disclosure will be described.

In the present embodiment, an example will be described, in which operations of open-close doors 7 and 8 when an evaporation condition is satisfied is changed from those of the first embodiment. In the present embodiment, descriptions of a part similar or equivalent to a part of the first embodiment will be omitted or simplified.

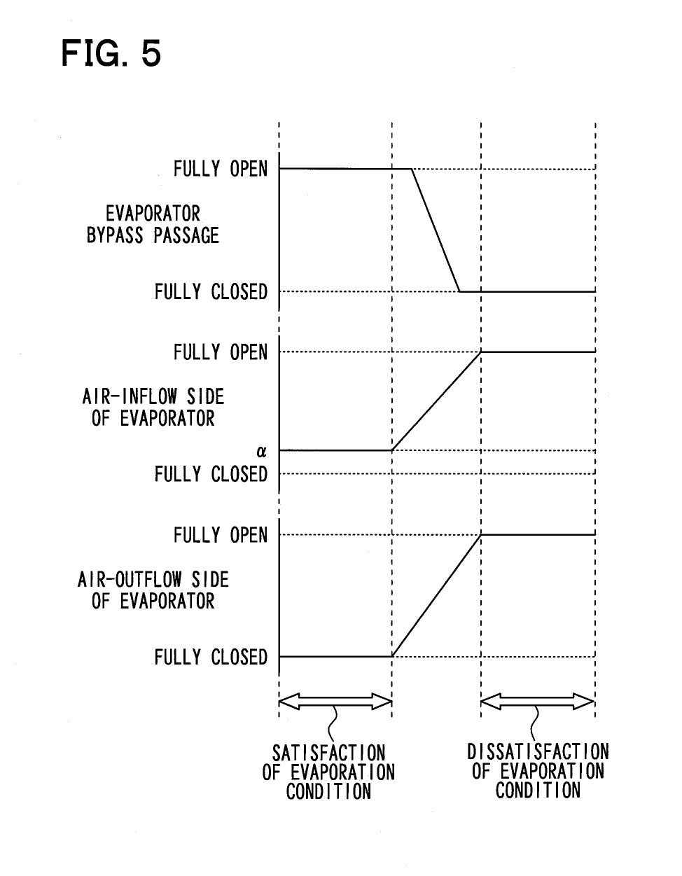

When the evaporation condition is satisfied, an air-conditioning controller 50 of the present embodiment controls, as shown in an operational-characteristic diagram of FIG. 5, the open-close doors 7 and 8 to open the evaporator bypass passage 6 and to close the air-outflow side of the evaporator 5. The air-conditioning controller 50 controls the air-outlet doors 15 to 17 to open at least one of the vehicle-compartment inside outlet 12 to 14. Furthermore, with respect to the air-inflow side of the evaporator 5, a first inflow-side door 7a of the inflow-side open-close door 7 is controlled to open the air-inflow side of the evaporator 5 by a quite-small open degree α.

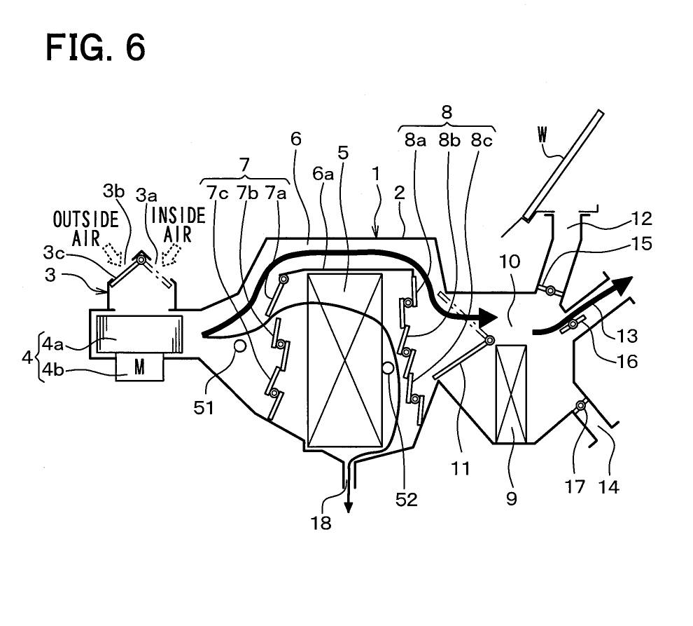

Accordingly, as shown in a whole configuration diagram of FIG. 6, most of air blown by a blower 4 flows into the evaporator bypass passage 6 with bypassing the evaporator 5. The air that has flowed into the evaporator bypass passage 6 is heated in a heater core 9 depending on an open degree of an air mix door 11. Subsequently, warm air that has passed through the heater core 9 and air that has passed through the heater-core bypass passage 10 are mixed on a downstream side of the heater core 9 and the heater-core bypass passage 10, thereby becoming air conditioned in temperature. The temperature-conditioned air is blown into the vehicle compartment through the vehicle-compartment inside outlets 12 to 14 depending on open and closed states of the air-outlet doors 15 to 17.

The air blown by the blower 4 flows into the evaporator 5 through the air-inflow side of the evaporator 5 which is slightly opened by the first inflow-side door 7a of the inflow-side open-close door 7. The air-outflow side of the evaporator 5 is closed by the outflow-side open-close door 8, and the cool-air passage from the air-outflow side of the evaporator 5 to the vehicle-compartment inside outlets 12 to 14 is closed. Hence, air flowing into the evaporator 5 is blown out to outside the vehicle compartment together with unpleasant odor and wet air around the evaporator 5 through a drainage port 18 that functions as a vehicle-compartment outside outlet.

According to the vehicular air conditioner 100, the following effects are produced in addition to the effects described in the first embodiment. That is, in the vehicular air conditioner 100 of the present embodiment, the air-inflow side of the evaporator 5 is slightly opened, and the air-outflow side of the evaporator 5 is closed by the outflow-side open-close door 8, when the evaporation condition is satisfied. Accordingly, a tiny amount of air flowing into the evaporator 5 is capable of facilitating evaporation of condensed water attached to the evaporator 5, and additionally, unpleasant odor or wet air associated with evaporation of the condensed water around the evaporator 5 can be blown out to outside the vehicle compartment through the drainage port 18. As a result, unpleasant odor in the vehicle compartment and window fogging can be limited effectively.

### Other Embodiments

In the above, the embodiments of the present discloser are described, but the present disclosure is not limited to these and can be modified variously as following, for example.

(1) In the above-described respective embodiments, an example is described, in which whether the evaporation condition for evaporation of the condensed water attached to the evaporator 5 is satisfied or not is determined based on comparison between the dew-point temperature of air flowing into the evaporator 5 and the detection temperature of the evaporator temperature sensor 52, but not limited to this determination. For example, whether the evaporation condition is satisfied or not may be determined depending on a state of supply of refrigerant to the evaporator 5 because the condensed water attached to the evaporator 5 is easy to evaporate due to increase in temperature of the evaporator 5 when a supply of refrigerant to the evaporator 5 is stopped along with a stop of operation of the refrigeration cycle.

(2) In the above-described embodiments, a configuration is described, in which the first inflow-side door 7a of the inflow-side open-close door 7 opens or closes the evaporator bypass passage 6, but the configuration is not limited. For example, a configuration including another open-close door that opens or closes the evaporator bypass passage 6 separately from the inflow-side open-close door 7 may be employed.

(3) As described in the above-mentioned embodiments, a configuration provided with the open-close doors 7 and 8 on the air-inflow side and air-outflow side of the evaporator 5 is preferable because the evaporator 5 can be isolated in the casing 2, but the configuration is not limited.

For example, a configuration may be adopted, in which an open-close door is provided on either the air-inflow side or the air-outflow side of the evaporator 5, and the open-close door opens or closes the cool-air passage from the air-outflow side of the evaporator 5 to the vehicle-compartment inside outlets 12 to 14 and the evaporator bypass passage 6.

In this case also, when the evaporation condition is satisfied, the cool-air passage from the air-outflow side of the evaporator 5 to the vehicle-compartment inside outlets 12 to 14 is closed while the evaporator bypass passage 6 is opened. Accordingly, unpleasant odor in the vehicle compartment and window fogging can be restricted, and furthermore, air conditioned in temperature by, for example, the heater core 9 can be blown into the vehicle compartment through the evaporator bypass passage 6.

When the outflow-side open-close door 8 is provided on the air-outflow side of the evaporator 5, the first outflow-side door 8a of the outflow-side open-close door 8 may open or close the evaporator bypass passage 6, or another open-close door that opens or closes the evaporator bypass passage 6 may be provided and may open or close the evaporator bypass passage 6.

(4) As described in the above-mentioned respective embodiments, when the evaporation condition is satisfied, it is preferable that the open-close doors 7 and 8 completely close the passage from the evaporator 5 to the vehicle-compartment inside outlets 12 to 14, but it is not limited. The passage from the evaporator 5 to the vehicle-compartment inside outlets 12 to 14 may be slightly opened by the open-close doors 7 and 8. In this case, air blown by the blower 4 flows to the vehicle-compartment inside outlets 12 to 14 dominantly through the evaporator bypass passage 6 that is lower in flow resistance than the passage from the evaporator 5 to the vehicle-compartment inside outlets 12 to 14.

Hence, when the evaporation condition is satisfied, the passage from the evaporator 5 to the vehicle-compartment inside outlets 12 to 14 is substantially closed even though the passage from the evaporator 5 to the vehicle-compartment inside outlets 12 to 14 is slightly opened by the open-close doors 7 and 8. Thus, effects similar to those of the above-described respective embodiments can be obtained.

(5) In the above-described second embodiment, when the evaporation condition is satisfied, an example is described, in which air flowing into the evaporator 5 is emitted to outside the vehicle compartment through the drainage port 18, but it is not limited. For example, a vehicle-compartment outside outlet that guides air flowing into the evaporator 5 to outside the vehicle compartment may be provided in addition to the drainage port 18, and an open-close door that opens or closes the vehicle-compartment outside outlet may be provided.

(6) In the above-described respective embodiments, the evaporator 5 of the refrigeration cycle is adopted as the cooling heat exchanger, but the cooing heat exchanger is not limited to this. For example, an evaporator that evaporates refrigerant (heat medium) in an absorption refrigerating machine or an adsorption refrigerating machine, or a heat exchanger having a peltier module that fulfills its cooling function by Peltier effect may be used as the cooling heat exchanger.

(7) In the above-described respective embodiments, an example provided with the heater core 9 that is the heating heat exchanger which heats air in the casing 2 is explained, but is not limited. For example, the present disclosure may be applied to a vehicular air conditioner 100 that does not include the heating heat exchanger such as the heater core 9.

(8) Matters described in the above-described respective embodiments can be combined with each other arbitrarily. For example, the operations of the open-close doors 7 and 8 described in the respective embodiments may be switched depending on an operation state of the vehicular air conditioner 100.

What is claimed is:

1. A vehicular air conditioner comprising:
a casing having a vehicle-compartment inside outlet through which air is blown into a vehicle compartment;
a blower device that is disposed in the casing and blows air;
a cooling heat exchanger that is disposed in the casing and cools the air blown by the blower device;
a bypass passage through which the blown air is guided to the vehicle-compartment inside outlet with bypassing the cooling heat exchanger;
a passage open-close portion that opens or closes the bypass passage and a cool-air passage through which the blown air is guided to the vehicle-compartment inside outlet through the cooling heat exchanger;
an air-outlet open-close portion that opens or closes at least the vehicle-compartment inside outlet; and
a control portion that controls the passage open-close portion and the air-outlet open-close portion, wherein
the control portion controls the passage open-close portion to open the bypass passage and to substantially close the cool-air passage, and controls the air-outlet open-close portion to open the vehicle-compartment inside outlet, when an evaporation condition for evaporation of condensed water attached to the cooling heat exchanger is satisfied.

2. The vehicular air conditioner according to claim 1, wherein
the casing further includes a vehicle-compartment outside outlet through which the blown air flowing into the cooling heat exchanger is blown out to outside the vehicle compartment,
the air-outlet open-close portion is configured to be capable of opening or closing the vehicle-compartment outside outlet, and
the control portion controls the air-outlet open-close portion to open the vehicle-compartment outside outlet when the evaporation condition is satisfied.

3. The vehicular air conditioner according to claim 1, wherein
the passage open-close portion includes an inflow-side open-close portion that opens or closes an air-inflow side of the cooling heat exchanger in the cool-air passage, and an outflow-side open-close portion that opens or closes an air-outflow side of the cooling heat exchanger in the cool-air passage.

4. The vehicular air conditioner according to claim 1, further comprising a heat-exchanger temperature sensor that detects a temperature of the cooling heat exchanger, wherein
the evaporation condition is satisfied when a detection temperature of the heat-exchanger temperature sensor is higher than a dew-point temperature of air flowing into the cooing heat exchanger.

5. The vehicular air conditioner according to claim 4, further comprising a thermo-hygro sensor that detects a temperature and a humidity of air flowing into the cooling heat exchanger, wherein
the dew-point temperature is calculated based on a detection signal of the thermo-hygro sensor.
